(19) United States
(12) Patent Application Publication
(10) Pub. No.: US 2023/0249019 A1
(43) Pub. Date: Aug. 10, 2023

(54) TESTING OF LIFEBOAT SPRINKLER SYSTEMS

(71) Applicant: CONOCOPHILLIPS COMPANY, Houston, TX (US)

(72) Inventor: Erik LIEBERMANN, Stavanger (NO)

(21) Appl. No.: 18/161,293

(22) Filed: Jan. 30, 2023

Related U.S. Application Data
(60) Provisional application No. 63/308,102, filed on Feb. 9, 2022.

(51) Int. Cl. A62C 37/50; A62C 3/10

(52) U.S. Cl. CPC A62C 37/50; A62C 3/10; B63C 9/02

(57) ABSTRACT

The invention relates to a method and apparatus for testing a lifeboat sprinkler system without launching the lifeboat. A tank (5) of freshwater is arranged adjacent the lifeboat (1) on a marine vessel or oil platform (2). A line (24) is connected from the tank (5) to the sprinkler system of the lifeboat (1). The pressure of the water supply is arranged by means of the location of the tank (5) and/or a regulating valve (23) to mimic the pressure of the seawater that the system would access from an inlet (14) in the lifeboat hull (15) if it were launched.

This application is a non-provisional application which claims benefit under 35 USC §119(e) to U.S. Provisional Application Ser. No. 63/308102 filed February 9^{th}, 2022 entitled “TESTING OF LIFEBOAT SPRINKLER SYSTEMS,” which is incorporated herein in its entirety.

### STATEMENT REGARDING FEDERALLY SPONSORED RESEARCH

None.

### FIELD OF THE INVENTION

This invention relates to the testing of lifeboat sprinkler systems, for example for lifeboats on an offshore installation such as an oil or gas production platform or an oil or gas tanker.

### BACKGROUND OF THE INVENTION

A lifeboat for an offshore oil or gas installation or tanker is normally provided with a sprinkler system to cool the surface of the vessel. The vessel is fitted with a pump with an inlet below the normal waterline which feeds a set of sprinklers arranged on top of the vessel. The lifeboat may be a freefall lifeboat, such as commonly used on offshore oil platforms, or it could be a more traditional type which in an emergency is lowered onto the sea.

Regular testing of the sprinkler system is highly desirable but involves launching the lifeboat and pumping seawater through the sprinkler system in the same way that would happen if the lifeboat were launched in an emergency. The launching and subsequent recovery of a lifeboat is a time-consuming operation. Furthermore, the testing of the sprinkler system leaves seawater in the pump and pipework and sprinkler nozzles which, unless flushed out, can lead to corrosion problems. Flushing the system with freshwater, if performed, of course further adds to the total time taken for the testing procedure. Regular launching of the lifeboat also involves wear and tear on the boat. For all these reasons, in many cases a decision is made not to test a lifeboat sprinkler system at all.

### BRIEF SUMMARY OF THE DISCLOSURE

The invention more particularly includes a process for testing a sprinkler system of at least one lifeboat on an offshore installation or a seagoing vessel without launching the lifeboat, wherein the sprinkler system comprises a pump and an inlet, the inlet being located below a normal waterline of the lifeboat; wherein the process is characterized by: a) providing a freshwater supply on the installation or vessel, the supply being located adjacent the lifeboat on the installation or vessel; b) connecting the freshwater supply to the sprinkler system of the lifeboat; c) switching on the lifeboat pump to draw freshwater through the sprinkler system.

The process may include the step of controlling, by a valve or other means, the static pressure of freshwater at an inlet of the sprinkler system pump. The static pressure at the pump inlet may be maintained at a pressure substantially equal to the static pressure of seawater at the pump inlet if the lifeboat were floating on the sea. Alternatively, the static pressure may be adjusted to compensate for differences in density and/or viscosity of freshwater and seawater. In either case, the objective is to simulate as closely as possible the load which the pump would experience if it were drawing up seawater through the inlet when the lifeboat was floating on the sea. During the test, the pump may be powered by the lifeboat’s propulsion engine, as it would be during an emergency deployment.

In another embodiment, a lifeboat sprinkler testing system for use on an offshore installation or a seagoing vessel comprises: a) at least one lifeboat located on the installation or vessel, the lifeboat including a sprinkler system comprising a pump and an inlet, the inlet being located below a normal waterline of the lifeboat; b) a tank of freshwater located adjacent the lifeboat on the installation or vessel; c) wherein the height of the tank location relative to the inlet of the lifeboat sprinkler system provides a static pressure of freshwater at least equivalent to the static pressure of seawater at the inlet if the lifeboat were floating on the sea; d) a conduit and connector for connecting the tank to the lifeboat inlet to allow freshwater to pass from the tank into the lifeboat sprinkler system when the pump is turned on.

The system may further comprise a valve for regulating the static pressure of freshwater supplied to an inlet of the sprinkler system pump such that the pressure is substantially equivalent to the static pressure of seawater at the pump inlet if the lifeboat were floating on the sea.

The valve alternatively may be designed to regulate the static pressure of freshwater to take into account differences in viscosity and/or density of seawater and freshwater.

Examples and various features and advantageous details thereof are explained more fully with reference to the exemplary, and therefore non-limiting, examples illustrated in the accompanying drawings and detailed in the following description. Descriptions of known starting materials and processes can be omitted so as not to unnecessarily obscure the disclosure in detail. It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

Additionally, any examples or illustrations given herein are not to be regarded in any way as restrictions on, limits to, or express definitions of, any term or terms with which they are utilized. Instead these examples or illustrations are to be regarded as being described with respect to one particular example and as illustrative only. Those of ordinary skill in the art will appreciate that any term or terms with which these examples or illustrations are utilized encompass other examples as well as implementations and adaptations thereof which can or cannot be given therewith or elsewhere in the specification and all such examples are intended to be included within the scope of that term or terms. Language designating such non-limiting examples and illustrations includes, but is not limited to: “for example,” “for instance,” “e.g.,” “In some examples,” and the like.

Although the terms first, second, etc. can be used herein to describe various elements, components, regions, layers and/or sections, these elements, components, regions, layers and/or sections should not be limited by these terms. These terms are only used to distinguish one element, component, region, layer or section from another. Thus, a first element, component, region, layer or section discussed below could be termed a second element, component, region, layer or section without departing from the teachings of the present inventive concept.

While preferred examples of the present inventive concept have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

### BRIEF DESCRIPTION OF THE DRAWINGS

A more complete understanding of the present invention and benefits thereof may be acquired by referring to the follow description taken in conjunction with the accompanying drawings in which:

FIG. 1 is a schematic view of a system in accordance with the invention, including lifeboats and water supply; and

FIG. 2 is a schematic view of the pump and valves and a partial view of the conduits of the system of FIG. 1.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

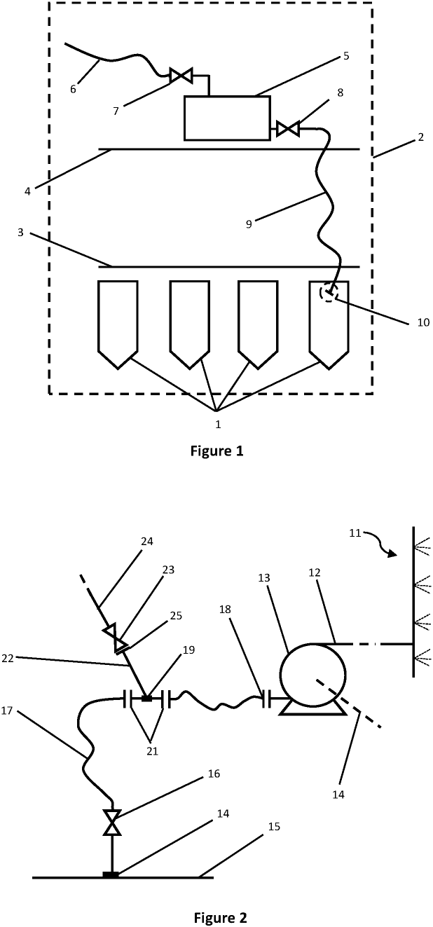

FIG. 1 shows a row of lifeboats 1 located on an offshore oil producing platform represented schematically by dashed line box 2. An access deck is shown at 3. Located on an upper deck 4 at a higher level than the access deck 3 is a freshwater tank 5 containing approximately 3,000 litres of freshwater. The tank is fed by a hose 6 with valve 7 coming from the platform’s freshwater system.

An outlet valve 8 from the tank 5 may be opened to allow freshwater to flow through a line 9 to feed water into one or more lifeboat sprinkler systems, indicated generally at 10 in FIG. 1. In the arrangement shown, the freshwater flows to the lifeboat sprinkler system under the static head of pressure created by the elevation of the tank 5 above the lifeboat, but alternatively the water pressure could be created by means of a pump (not shown).

A lifeboat sprinkler system is shown schematically in FIG. 2. A series of sprinkler nozzles 11 is fed by a line 12 from a pump 13 in the lifeboat. The drive for the pump is shown schematically by dashed line 14 and is normally from the lifeboat’s propulsion engine, though alternatively there could be a separate drive, e.g. a battery powered motor. In normal operation, after the lifeboat is launched, the pump 13 draws seawater from an inlet 14 which is located in the hull 15 of the lifeboat, below the normal water line. A valve 16 allows seawater to enter the system. Normally this valve is manually opened after launching the lifeboat and before starting the seawater pump. Water travels from the valve 16 to the pump 13 via a line 17 which is connected to the pump inlet by a connector 18. All these features of the sprinkler system itself are conventional.

In the system according to the invention, the sprinkler system may be modified to receive a freshwater supply for the purposes of testing. Although this is not essential, since water could theoretically be supplied directly to the inlet 14 in the hull 15 of the lifeboat, the system is preferably modified to accept the test water at a junction 19 in the line 17. The line 17 may be severed and a section 20 of line, e.g. rigid pipe, may be inserted into the line 17 by means of connectors 21. The junction 19 is incorporated into the new section 20 and a freshwater inlet line 22 and valve 23 connected to the junction 19. The valve 23 may allow the freshwater inlet line 22 to be closed completely or may be operable to control the static pressure of freshwater in the line 22. Valve 23 is critical and needs to have a procedural fail safe mechanism. The reason for this is that if a test is done with this new system incorporated and the operator forgets to close the valve then the boat may either sink or the sprinkler system will not work since line 22 is open.

When a sprinkler test is to be performed, a line 24 from the freshwater tank is connected to the inlet line 22. As shown, a connector 25 is incorporated into the valve arrangement 23 on the downstream side of the valve, but of course the valve could be part of the sprinkler system in the lifeboat 1 or part of the installation on the platform 2. In a test, the valve 16 is shut off to prevent water flowing out of the normal seawater inlet and the valves 8 and 23 are opened so that freshwater flow to the sprinkler system. The lifeboat pump 13 is operated and water is thereby pumped under pressure to the sprinkler nozzles 11 as it would be during normal operation.

The static head of the water fed to the pump may be controlled by the location of the tank 5 above the lifeboat 1, by adjusting (either manually or by some automated system) the valve 8 on the tank outlet or the valve 23 at the inlet to the sprinkler system, or by any or all of these things.

The line 24 may be permanently connected to the lifeboat and the connector 25 may be a quick release connector, such that the lifeboat could be launched in an emergency and the connection to the freshwater supply automatically broken. More normally, the freshwater supply would be connected to the sprinkler system only when a test was being performed.

A permanent modification by installing T-piece may impact the certification of the lifeboat as a whole, so an alternative procedure may be simply to disconnect the inlet line to the pump and connect the temporary line from the freshwater tank during the test, disconnect it after the test and assemble the system back to the solution given in the certification of the boat. In this case, the system and method would be identical to that described above except that the connectors 21 and joint 19 would be omitted from the arrangement shown in FIG. 2 and, instead, the line 22 would be connected to the pump at connector 18 adjacent the inlet.

It will be apparent to the skilled reader that the testing of a lifeboat sprinkler system as described above will take very little time since it involves simply the operation of one or two valves. In contrast, previous methods of testing involved launching the lifeboat with at least one crew member on board to activate the sprinkler system and monitor its function, and then retrieving the lifeboat and crew member. The retrieval operation may take many hours not to mention the wear and tear on the lifeboat from repeated launches. In addition, the use of seawater for tests presents additional risk of corrosion of the pipework, valves and pump of the sprinkler system.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for testing a sprinkler system of at least one lifeboat on an offshore installation or a seagoing vessel without launching the lifeboat, wherein the sprinkler system comprises a pump and an inlet, the inlet being located below a normal waterline of the lifeboat; wherein the process is characterized by:
a) providing a freshwater supply on the installation or vessel, the supply being located adjacent the lifeboat on the installation or vessel;
b) connecting the freshwater supply to the sprinkler system of the lifeboat;
c) switching on the lifeboat pump to draw freshwater through the sprinkler system.

2. The process according to claim 1, including the step of controlling, by a valve or other means, the static pressure of freshwater at an inlet of the lifeboat pump.

3. The process according to claim 2, wherein the static pressure of freshwater at the pump inlet in the testing process is substantially equal to the static pressure of seawater at the pump inlet if the lifeboat were floating on the sea.

4. The process according to claim 2, wherein the static pressure at the pump inlet is adjusted to compensate for differences in density and/or viscosity of freshwater and seawater.

5. The process according to claim 1 wherein the lifeboat has a propulsion engine for propulsion of the lifeboat and, during the testing process, the pump is driven from the propulsion engine.

6. A lifeboat sprinkler testing system for use on an offshore installation or a seagoing vessel, the system comprising:
a) at least one lifeboat located on the installation or vessel, the lifeboat including a sprinkler system comprising a pump and an inlet, the inlet being located below a normal waterline of the lifeboat; characterized by:
b) a tank of freshwater located adjacent the lifeboat on the installation or vessel;
c) wherein the height of the tank location relative to the inlet of the lifeboat sprinkler system provides a static pressure of freshwater at least equivalent to the static pressure of seawater at the inlet if the lifeboat were floating on the sea;
d) a conduit and connector for connecting the tank to the lifeboat sprinkler system to allow freshwater to pass from the tank into the lifeboat sprinkler system when the pump is turned on.

7. The system according to claim 6, further comprising a valve for regulating the static pressure of freshwater at an inlet of the pump such that the pressure is substantially equivalent to the static pressure of seawater at the pump inlet if the lifeboat were floating on the sea.

8. The system according to claim 7, further comprising a valve for regulating the static pressure of freshwater at the pump inlet to take into account differences in viscosity and/or density of seawater and freshwater.
